(19) United States
(12) Patent Application Publication
(10) Pub. No.: US 2020/0394600 A1
(43) Pub. Date: Dec. 17, 2020

(54) FIRE PROTECTION INSPECTION METHOD, FIRE PROTECTION INSPECTION DEVICE, AND REMOTE DEVICE

(71) Applicants: HONGFUJIN PRECISION ELECTRONICES(YANTAI)CO.,LTD., Yantai (CN); HON HAI PRECISION INDUSTRY CO., LTD., New Taipei (TW)

(72) Inventors: HUI-TSU KUO, New Taipei (TW); FU-QIANG HE, Shenzhen (CN); KUNG-CHIEH CHENG, New Taipei (TW); JUN-QING ZHAO, Yantai (CN)

(21) Appl. No.: 16/874,597

(22) Filed: May 14, 2020

(30) Foreign Application Priority Data
Jun. 14, 2019 (CN) 201910516225.5

(51) Int. Cl. G06Q 10/08; G08B 29/14; H04Q 9/00; G06Q 10/10; G06Q 50/26; G06Q 30/00; G06K 7/14; G01S 19/42

(52) U.S. Cl. CPC G06Q 10/087; G08B 29/145; H04Q 9/00; G01S 19/42; G06Q 50/26; G06Q 30/0185; G06K 7/1417; G06Q 10/10

(57) ABSTRACT

A fire protection inspection method includes acquiring basic information of at least one fire protection device, sending the basic information to a remote device, comparing the basic information to preset standard information, analyzing and summarizing comparison results, and generating an inspection report. The basic information includes location information and image information of the fire protection device.

### FIELD

The subject matter herein generally relates to fire protection, and more particularly to a fire protection inspection method implemented by a fire protection inspection device and a remote device in communication with the fire protection inspection device.

### BACKGROUND

In order to improve and maintain original performance of equipment, the production equipment is inspected by spot inspection for abnormalities so that hidden dangers and defects of the equipment can be detected and treated. In the current fire protection inspection procedures, paper inspection forms are often used, and results of inspection are recorded on the inspection forms. Since the paper forms cannot be stored for a long time, the inspection data needs to be manually entered into a computer. However, manual entry takes a long time and is inefficient.

### BRIEF DESCRIPTION OF THE DRAWINGS

Implementations of the present disclosure will now be described, by way of embodiments, with reference to the attached figures.

FIG. 1 is a diagram of an application environment of a fire protection inspection device and a remote device.

FIG. 2 is a hardware architecture diagram of an embodiment of the fire protection inspection device.

FIG. 3 is a hardware architecture diagram of an embodiment of the remote device.

FIG. 4 is a schematic diagram of function modules of an embodiment of a fire protection inspection control system.

FIG. 5 is a schematic diagram of function modules of an embodiment of a remote control system.

FIG. 6 is a flowchart of an embodiment of a fire protection inspection method.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

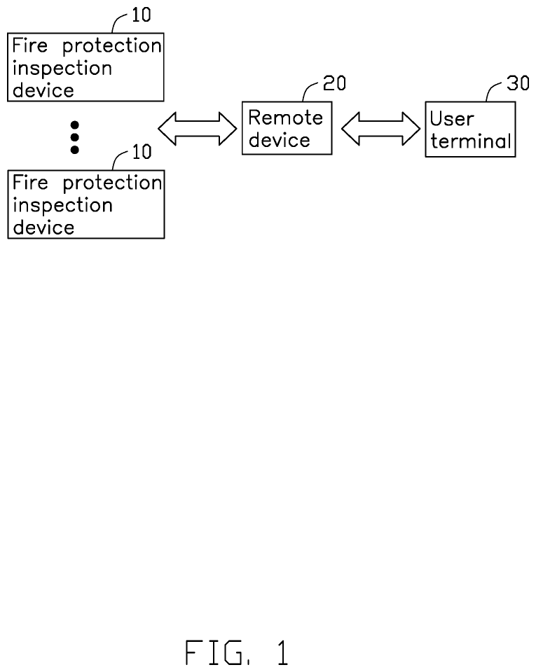

FIG. 1 shows a diagram of an application environment of a fire protection inspection device 10 and a remote device 20. The fire protection inspection device 10 is configured to inspect a plurality of fire protection devices placed in a fire protection area. The remote device 20 is communicatively connected to at least one fire protection inspection device 10, and the remote device 20 is communicatively connected to at least one user terminal 30. In one embodiment, the fire protection area may be a factory park, a school, a shopping mall, an office building, or the like.

In one embodiment, the fire protection inspection device 10 and the user terminal 30 may be the same device.

In at least one embodiment, the fire protection inspection device 10 may be a smart phone installed with a fire protection inspection application, the remote device 20 may include one or more servers, and the user terminal 30 may be a smart phone or a computing device installed with the fire protection inspection application.

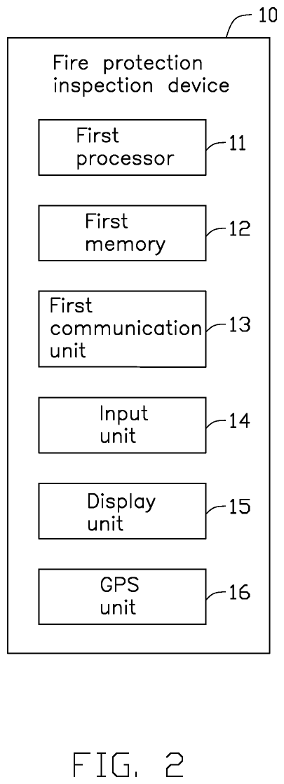

FIG. 2 shows a hardware architecture diagram of an embodiment of the fire protection inspection device 10. The fire protection inspection device 10 includes at least a first processor 11, a first memory 12, a first communication unit 13, an input unit 14, a display unit 15, and a global positioning system (GPS) unit 16.

The first processor 11 is electrically connected to the first memory 12, the first communication unit 13, the input unit 14, the display unit 15, and the GPS unit 16. The first processor 11 may be a central processing unit (CPU), a microprocessor, or other data processing chip suitable for implementing various instructions.

The first memory 12 is configured to store various types of data, such as program codes of the fire protection inspection device 10, and implement high-speed and automatic completion of access to programs or data in the fire protection inspection device 10.

The first memory 12 may be a hard disk, a floppy disk, a U-disk, a random access storage device, or the like.

In at least one embodiment, the first memory 12 may be an internal storage system, such as a flash memory, a random access memory (RAM), or a read-only memory (ROM).

In at least one embodiment, the first memory 12 may also be a storage system, such as a video disc, a memory card, or a data storage medium. The first memory 12 further includes an unstable or stable storage device.

The first communication unit 13 may communicate with the remote device 20 in a wired or wireless communication manner.

The input unit 14 is configured to receive user identity information, image information of the fire protection devices, and device identification code information of the fire protection devices.

The user identity information includes one or more of facial information, iris information, fingerprint information, finger vein information, palm vein information, palm print information, sound information, and account information.

The fire protection devices include one or more of a pushcart dry powder fire extinguisher, a handheld dry powder fire extinguisher, a fire hydrant, a pushcart carbon dioxide fire extinguisher, a handheld carbon dioxide fire extinguisher, an exit sign, an evacuation indicator, a fire emergency light, a fire door, and a fire shutter.

In one embodiment, each of the fire protection devices is provided with a unique device identification code (such as a two-dimensional code), and the device identification code may include corresponding location information of the fire protection device and a type of the fire protection device. The fire protection inspection device 10 identifies the device identification code on the fire protection device to obtain corresponding location information of the fire protection equipment.

The image information includes one or more of an indicator of a pressure gauge, a brightness of the indicator, appearance characteristics of a safety pin, appearance characteristics of a nozzle, and appearance characteristics of a hose.

The input unit 14 may include one or more of a key, a touch screen, and a camera. In one embodiment, the input unit 14 includes at least a touch screen and a camera.

The display unit 15 is configured to display various information processed by the first processor 11, such as the user identity information and check reports. The display unit 15 may be a display screen or the like.

The GPS unit 16 is configured to obtain real-time location information of the fire protection inspection device 10.

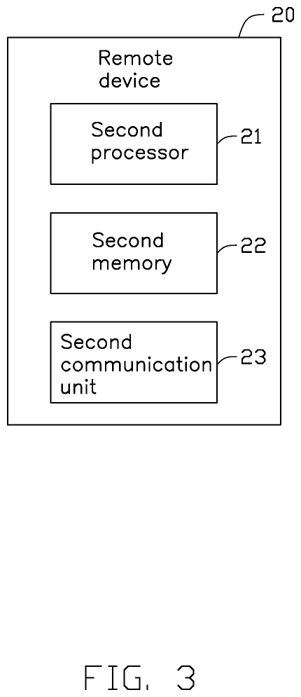

FIG. 3 shows a hardware architecture diagram of an embodiment of the remote device 20. The remote device 20 includes at least a second processor 21, a second memory 22, and a second communication unit 23.

The second processor 21 is communicatively connected to the second memory 22 and the second communication unit 23. The second processor 21 may be a CPU, a microprocessor, or other data processing chip suitable for implementing various instructions.

The second memory 22 stores various types of data such as program codes in the remote device 20 and implements high-speed and automatic access to programs or data during the operation of the remote device 20.

The second memory 22 may be a hard disk, a floppy disk, a U-disk, a random access storage device, or the like.

In at least one embodiment, the second memory 22 may be an internal storage system, such as a flash memory, a RAM, and a ROM.

In at least one embodiment, the second memory 22 may also be a storage system, such as a video disc, a memory card, or a data storage medium. The second memory 22 further includes an unstable or stable storage device.

The second communication unit 23 may communicate with the first communication unit 13 of the at least one user terminal 30 and the at least one fire protection inspection device 10 through a wired or wireless communication method.

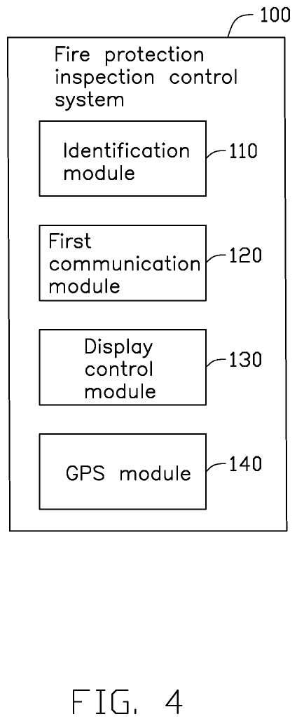

FIG. 4 is a schematic diagram of function modules of an embodiment of a fire protection inspection control system 100. The fire protection inspection control system 100 runs on the fire protection inspection device 10. The fire protection inspection control system 100 includes function modules composed of a plurality of program code segments. The program codes of each program code segment in the fire protection inspection control system 100 may be stored in the first memory 12 and executed by the first processor 11 to implement the functions of the fire protection inspection control system 100. The fire protection inspection control system 100 includes at least an identification module 110, a first communication module 120, a display control module 130, and a GPS module 140.

The identification module 110 is configured to obtain user identity information input through the input unit 14 to identify a user identity. The identification module 110 is further configured to identify a device identification code of a fire protection device input through the input unit 14 to obtain location information of the fire protection device.

The user identity includes one or more of facial information, iris information, fingerprint information, finger vein information, palm vein information, palm print information, sound information, and account information.

The first communication module 120 is configured to send the user identity information, the image information of the fire protection device, the location information of the fire protection device, and the real-time location information of the fire protection inspection device 10 through the first communication unit 13 to the remote device 20.

The display control module 130 is configured to control the display unit 15 to display various information processed by the first processor 11, such as a user identity and an inspection report.

When the fire protection inspection device 10 identifies the device identification code, the fire protection inspection device 10 further obtains base information of the fire protection device and controls the display unit 15 to display the base information through the display control module 130. The base information includes at least one of a date of manufacture of the fire protection device, a validity period of the fire protection device, a normal range of an indicator of a pressure gauge, a normal brightness of the indicator, normal appearance characteristics of a safety pin, normal appearance characteristics of a nozzle, normal appearance characteristics of a hose, a production date, location information, and a weight. In one embodiment, the display unit 15 may be a display screen, a touch screen, or the like.

The GPS module 140 is configured to control the GPS unit 16 to obtain real-time location information of the fire protection inspection device 10.

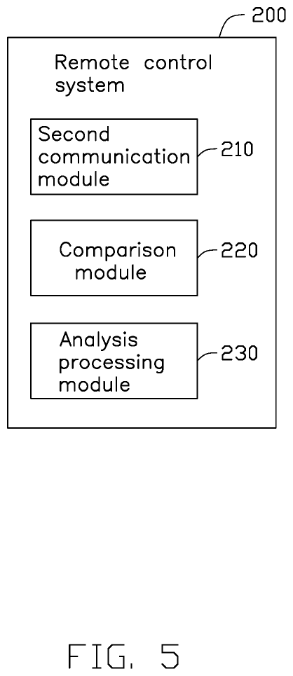

FIG. 5 is a schematic diagram of function modules of an embodiment of a remote control system 200. The remote control system 200 runs on the remote device 20. The remote control system 200 includes function modules composed of a plurality of program code segments. The program codes of each program code segment in the remote control system 200 may be stored in the second memory 22 and executed by the second processor 21 to implement functions of the remote control system 200. The remote control system 200 includes at least a second communication module 210, a comparison module 220, and an analysis processing module 230.

The second communication module 210 is configured to receive, through the second communication unit 23, the basic information of the fire protection device, the location information of the fire protection device, the user identity information, and the real-time location information of the fire protection inspection device 10 sent from the fire protection inspection device 10.

The comparison module 220 is configured to compare the received basic information of the fire protection device to preset standard information and compare the received location information of the fire protection device to the real-time location of the fire protection inspection device 10 when the fire protection inspection device 10 acquired the basic information of the fire protection device.

The preset standard information is standard information corresponding to the basic information.

It can be understood that in at least one embodiment, whether each type of the basic information is abnormal can be determined by manually collecting image information of a perceived abnormality, and comparing the collected image information to the preset standard information through the comparison module 220.

The comparison result includes at least an abnormal condition of the fire protection device, such as if a pressure indication exceeds a normal indication range, a fire emergency light goes out, and the location of the fire protection device is not consistent with the corresponding real-time location of the fire protection inspection device 10.

The analysis processing module 230 is configured to analyze and summarize the comparison results of the comparison module 220.

Specifically, the analysis processing module 230 summarizes the comparison results and generates an inspection report. The inspection report includes at least one of an inspection summary table, a scrap summary table, and an inspection information analysis table. The inspection summary table includes one or more of the user identity of the fire protection device, the number of the fire protection devices, the type of the fire protection devices, the location information of the fire protection devices, the image information of the fire protection devices, the abnormal information of the fire protection inspection devices, and the real-time location information of the fire protection inspection device 10. The scrap summary table includes one or more of the number of the fire protection devices, the type of the fire protection devices, the location information of the fire protection devices, a reason for scrapping, and image information of a scrapping location. The inspection information analysis table is an analysis of the fire protection devices, such as analysis of the cause of scrapping and a regional analysis of scrapped fire protection devices. In one embodiment, the inspection report may be presented in a table manner according to a weekly, monthly, and quarterly cycle, and may also be presented in a fan chart, bar chart, or other manner.

The second communication module 210 is further configured to send the inspection report to the fire protection inspection device 10 or the user terminal 30.

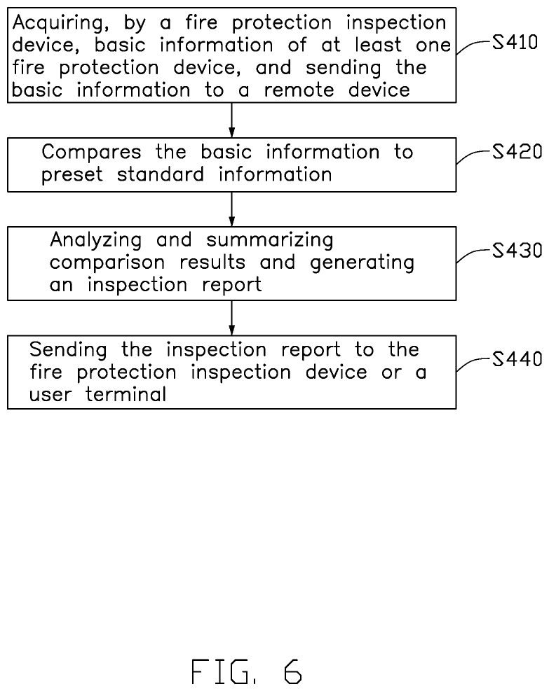

FIG. 6 shows a flowchart of an embodiment of a fire protection inspection method. The fire protection inspection method is only an example because there are many ways to implement the method. The fire protection inspection method may be implemented by execution by the modules shown in FIG. 4 and FIG. 5. According to different embodiments, the order of blocks in the method may be changed, and some blocks may be removed or combined.

Block S410: The fire protection inspection device 10 acquires basic information of at least one fire protection device, and sends the basic information to the remote device 20. The basic information includes location information and image information of the fire protection device.

Block S420: The remote device 20 compares the basic information to preset standard information.

Block S430: The remote device 20 analyzes and summarizes comparison results obtained in block S420 and generates an inspection report.

Block S440: The remote device 20 sends the inspection report to the fire protection inspection device 10 or the user terminal 30.

Specifically, by entering an operation instruction in the fire protection inspection device 10 or the user terminal 30, the inspection report sent by the remote device 20 can be received.

In one embodiment, the user terminal 30 is a computing device on which the fire protection inspection application is installed, and the fire protection inspection device 10 is a smart phone on which the fire protection inspection application is installed.

The fire protection inspection device 10 acquires the basic information of the at least one fire protection device, the remote device 20 compares the basic information to the preset standard information, and the comparison results are analyzed and summarized in the inspection report. The inspection report is checked by the fire protection inspection device 10 in real time so that maintenance can be performed in a timely manner.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A fire protection inspection method comprising:
acquiring, by a fire protection inspection device, basic information of at least one fire protection device, and sending the basic information to a remote device, wherein the basic information comprises location information and image information of the at least one fire protection device;
comparing, by the remote device, the basic information to preset standard information; and
analyzing and summarizing, by the remote device, comparison results and generating an inspection report.

2. The fire protection inspection method of claim 1, wherein:
the image information comprises one or more of an indicator of a pressure gauge, a brightness of the indicator, appearance characteristics of a safety pin, appearance characteristics of a nozzle, and appearance characteristics of a hose; and
the inspection report comprises one or more of an inspection summary table, a scrap summary table, and an inspection information analysis table.

3. The fire protection inspection method of claim 1, wherein a method of acquiring the location information of the at least one fire protection device comprises:
identifying, by the fire protection inspection device, a device identification code on the at least one fire protection device, wherein the device identification code comprises the location information of the at least one fire protection device.

4. The fire protection inspection method of claim 3, wherein:
when the fire protection inspection device identifies the device identification code, the fire protection inspection device further acquires base information of the at least one fire protection device; and
the base information comprises one or more of a date of manufacture of the at least one fire protection device, a validity period of the at least one fire protection device, a normal range of an indicator of a pressure gauge, a normal brightness of the indicator, normal appearance characteristics of a safety pin, normal appearance characteristics of a nozzle, normal appearance characteristics of a hose, a production date, location information, and a weight.

5. The fire protection inspection method of claim 3, wherein:
when the fire protection inspection device acquires the basic information of the at least one fire protection device, the fire protection inspection device further acquires a real-time location of the fire protection inspection device and sends the real-time location to the remote device.

6. The fire protection inspection method of claim 1, wherein before acquiring the basic information of the at least one fire protection device, the method further comprises:
acquiring user information; wherein:
the fire protection inspection device sends the user information with the basic information of the at least one fire protection device to the remote device.

7. A fire protection inspection device comprising:
a communication unit configured to communicate with a remote device;
an input unit;
a processor; and
a memory configured to store a plurality of instructions, which when executed by the processor, cause the processor to:
acquire, through the input unit, basic information of at least one fire protection device; and
send the basic information to the remote device;
wherein the basic information comprises location information and image information of the at least one fire protection device.

8. The fire protection inspection device of claim 7, wherein:
the image information comprises one or more of an indicator of a pressure gauge, a brightness of the indicator, appearance characteristics of a safety pin, appearance characteristics of a nozzle, and appearance characteristics of a hose.

9. The fire protection inspection device of claim 7, wherein the processor acquires the location information of the at least one fire protection device by:
identifying, through the input unit, a device identification code on the at least one fire protection device, wherein the device identification code comprises the location information of the at least one fire protection device.

10. The fire protection inspection device of claim 9, wherein:
when the processor identifies the device identification code, the processor further acquires base information of the at least one fire protection device; and
the base information comprises one or more of a date of manufacture of the at least one fire protection device, a validity period of the at least one fire protection device, a normal range of an indicator of a pressure gauge, a normal brightness of the indicator, normal appearance characteristics of a safety pin, normal appearance characteristics of a nozzle, normal appearance characteristics of a hose, a production date, location information, and a weight.

11. The fire protection inspection device of claim 9, further comprising a global positioning system (GPS) unit, wherein:
when the processor acquires the basic information of the at least one fire protection device, the processor further acquires a real-time location of the fire protection inspection device through the GPS unit; and
the processor sends the real-time location with the basic information of the at least one fire protection device to the remote device.

12. The fire protection inspection device of claim 9, wherein before acquiring the basic information of the at least one fire protection device, the processor is further configured to:
acquire user information; wherein:
the processor sends the user information with the basic information of the at least one fire protection device to the remote device.

13. A remote device comprising:
a communication unit configured to communicate with a fire protection inspection device;
a processor; and
a memory storing a plurality of instructions, which when executed by the processor, cause the processor to:
receive basic information of a fire protection device sent by the fire protection inspection device, wherein the basic information comprises location information and image information of the fire protection device;
compare the received basic information to preset standard information; and
analyze and summarize comparison results and generate an inspection report.
